(19) United States
(12) Patent Application Publication
(10) Pub. No.: US 2016/0265651 A1
(43) Pub. Date: Sep. 15, 2016

(54) PLANET CARRIER WITH INTEGRATED LUBRICANT SUPPLY

(71) Applicants: ZF Friedrichshafen AG, Friedrichshafen (DE); ZF Wind Power Antwerpen N.V., Lommel (BE)

(72) Inventor: Warren SMOOK, Huldenberg (BE)

(21) Appl. No.: 15/031,773

(22) PCT Filed: Oct. 10, 2014
(86) PCT No.: PCT/EP2014/071710

§ 371 Date: Apr. 25, 2016

(30) Foreign Application Priority Data
Nov. 11, 2013 (DE) 10 2013 222 847.3

(51) Int. Cl. F16H 57/04; F16H 57/08; F03D 15/00; F16H 1/28

(52) U.S. Cl. CPC F16H 57/0479; F16H 57/043; F16H 1/28; F16H 57/082; F03D 15/00; F05B 2260/40311; F05B 2260/98

(57) ABSTRACT

A transmission, particularly for a wind power machine, with a transmission housing and with at least one planetary stage. The planetary stage includes at least one planetary carrier with at least one first duct for conveying lubricant. The planetary carrier is mounted to rotate in the transmission housing by way of at least one bearing, which can, in particular, be the rotor bearing. At least part of the transmission housing, at least part of the planetary carrier and at least part of the bearing together form a cavity. The first duct is designed such that lubricant can emerge from the first duct into the cavity so that at least some of the lubricant is directed toward the bearing.

This application is a National Stage completion of PCT/EP2014/071710 filed Oct. 10, 2014, which claims priority from German patent application serial no. 10 2013 222 847.3 filed Nov. 11, 2013.

### FIELD OF THE INVENTION

The present invention concerns the supply of lubricant to a bearing of a planetary carrier in a planetary stage, in particular in a transmission of a wind power machine.

### BACKGROUND OF THE INVENTION

In wind power machines, the rotor bearing in particular is exposed to severe loading. Accordingly it may be necessary to supply the rotor bearing with pressurized lubricant. Usually, for this an external oil line is fitted, which runs outside the transmission housing.

Such a line incurs additional costs. Moreover, due to its exposed position, the line is liable to be damaged. Particularly during assembly or while maintenance work is being carried out, the line can be damaged. Furthermore the rotor bearing is often very large. Space is therefore limited in the area of the rotor bearing, and this makes the supply of lubricant more difficult.

### SUMMARY OF THE INVENTION

The purpose of the present invention is to supply lubricant to a bearing of a planetary carrier, which may in particular be the rotor bearing of a wind power machine, while avoiding the disadvantages mentioned as inherent in the prior art.

According to the invention, this objective is achieved by a transmission having the characteristics as described below. Further advantageous design features and developments are also described below.

A transmission according to the invention comprises at least one planetary stage. A planetary stage is understood to mean an epicyclic gear system, which is part of the transmission according to the invention.

A transmission housing belonging to the transmission according to the invention encapsulates the planetary stage. The transmission housing can consist of more than one housing component. Preferably, the transmission housing comprises a first housing half and a second housing half. The two housing halves can be connected directly to one another. Preferably, however, there is a ring gear between the two housing halves. Thus, the ring gear forms a third housing component.

In addition the planetary stage comprises at least one planetary carrier. This has at least one first duct for conveying lubricant. As the lubricant, in particular conventional transmission oil is provided.

The planetary carrier is mounted to rotate in the housing by means of at least one bearing.

At least one part of the transmission housing, at least one part of the planetary carrier and at least one part of the bearing form between them a cavity. From this it is to be understood that the part of the transmission housing, the part of the planetary carrier and the part of the bearing each form part of the bounding surface of the cavity. In particular, in addition to the parts of the transmission housing, the planetary carrier and the bearing, the cavity can be delimited by further components of the transmission. However, it is also possible for the cavity to be delimited exclusively by the three components.

According to the invention, lubricant is supplied to the bearing by way of a first duct. For that purpose the first duct is designed such that lubricant can emerge from the first duct into the cavity. Thus, the first duct opens into the cavity. Furthermore, the first duct is designed such that at least some of the lubricant emerging from the first duct into the cavity can make its way into the bearing. In this way, in particular the components of the bearing to be lubricated, i.e. the inner race and the outer race and the rolling elements in the case of a roller bearing or the sliding surfaces in the case of a slide bearing, are wetted with lubricant.

The lubricant emerging from the first duct into the cavity can be transferred into the bearing in two ways. On the one hand, the first duct can be designed such that the lubricant from the first duct is sprayed into the bearing. Thus, the lubricant emerging from the first duct into the cavity crosses an air gap between the first duct and the bearing, and reaches the bearing along a ballistic path. On its way through the cavity, the lubricant emerging from the first duct does not contact any other components of the transmission until it reaches the first bearing.

On the other hand, the first duct can be designed such that at least some of the lubricant emerging from the first duct into the cavity flows into the bearing. This means that the lubricant emerging from the first duct into the cavity flows along bounding surfaces of the cavity into the bearing. In particular, the lubricant can flow over the planetary carrier, or along that part of the planetary carrier which forms a bounding surface of the cavity, into the bearing. In other words the planetary carrier is designed such that it can guide the lubricant emerging from the first duct into the cavity, into the bearing.

Preferably, the transmission is provided with pressure lubrication. In that case the lubricant, in particular the lubricant emerging from the first duct into the cavity, is pressurized. Pressure lubrication, in particular for the transmission of a wind power machine, is known from the prior art.

A person with knowledge of the field is in a position to determine the optimum point where the lubricant should emerge from the first duct into the cavity. Possibly, however, that point is located in an area of the transmission which is not covered by the planetary carrier, for example the cavity. But to be able to extend the first duct up to the point determined, at least one element can be provided, which together with the planetary carrier forms the first duct and which is attached to the planetary carrier in such manner that the lubricant passing through the first duct then flows through the element. Thus, the lubricant does not emerge from the planetary carrier into the cavity, but rather, first flows from the planetary carrier into the element. It is from the element that the lubricant then emerges from the first duct into the cavity.

The use of such an element makes it possible to leave the planetary carrier largely unchanged even though a duct for conveying the lubricant is provided. It is only necessary to provide a bore in the planetary carrier, which forms part of the first duct. A further part of the first duct is formed by the element. A knowledgeable person can now optimize the shape and position of the first duct by modifying the element. For this, no modifications of the planetary carrier itself are needed.

If the first duct is designed such that the lubricant emerging from the first duct is sprayed into the bearing, a jet of lubricant is formed between the first duct and the bearing. To influence the properties of that jet in a selective manner, in an advantageous further development of the invention a nozzle is provided, from which the lubricant emerges. The first duct leads into this nozzle. For example, the nozzle enables the selective influencing of the spray pattern and/or the speed with which the lubricant emerges from the nozzle.

To supply lubricant to the first duct, the transmission housing preferably has at least one second duct for conveying lubricant. Lubricant is conveyed into this second duct from outside, for example by way of a pressure lubrication system by which the lubricant fed into the second duct is pressurized.

For lubricant to pass from the second duct into the first duct, at least one means is provided for directing at least some of the lubricant from the second duct into the first duct. In this case the first duct serves to convey the first fraction of the lubricant.

The means for directing the first fraction of the lubricant from the second duct into the first duct can be designed in various ways. In a first embodiment of the means for directing the first fraction of the lubricant, the duct system through which the lubricant is directed passes through the planetary bolts, i.e. at least one planetary bolt is designed as a means for directing the first fraction of the lubricant from the second duct into the first duct. Thus, the lubricant first flows through the second duct, then through the planetary bolt, and finally through the first duct. Between the second duct and the planetary bolt and between the planetary bolt and the first duct further means for directing the lubricant can also be provided.

A lubricant-carrying planetary bolt, i.e. a planetary bolt for directing the first fraction of the lubricant, is preferably provided with at least one third duct extending in the axial direction. The lubricant flows from the second duct through the third duct to the first duct.

Various embodiments are conceivable, which differ from one another in the number of lubricant-carrying planetary bolts. For example, just one planetary bolt can be designed to carry the lubricant. Alternatively all the planetary bolts, or a majority of the planetary bolts, can be lubricant-carrying, but the remaining ones not so.

Preferably, the planetary bolt is also designed as a means for directing a second fraction of the lubricant to at least one bearing by means of which a planetary gearwheel is mounted to rotate on the planetary bolt. Thus, while the first fraction of the lubricant passes through the first duct at least partially into the bearing on which the planetary carrier is mounted, a fourth duct in the planetary bolt directs the second fraction of the lubricant at least partially into the bearing on which the planetary gearwheel is mounted. This enables the bearing of the planetary carrier as well as the bearing of the planetary gearwheel to be supplied by a single, coherent duct system.

The fourth duct preferably extends perpendicularly to the third duct, in such manner that the third and fourth ducts intersect. Thus, the fourth duct divides the third duct into a first and a second part-section. From the second duct the lubricant flows through the first part-section of the third duct. The second fraction of the lubricant passes from there into the fourth duct, whereas the first fraction of the lubricant is directed through the second part-section of the third duct into the first duct. Preferred embodiments of the design of the fourth duct, the first part-section of the third duct, the second duct and a lubricant-carrying connection of the second duct to the third duct are described in the document WO 03/078870 A1.

The means for directing the first fraction of the lubricant from the second duct into the first duct can alternatively be made without using one of the planetary bolts. In this case the first duct passes through the planetary carrier, completely bypassing the planetary bolts.

Regardless of whether the lubricant is directed through a planetary bolt or bypasses the planetary bolts, a lubricant-carrying two-part connection is preferably provided between the transmission housing and the planetary carrier. Such a connection is described in the document WO 03/078870 A1.

In that case the second duct opens into a first part of the connection. This opening of the second duct into the first part can for example be in the form of a bore in the second part. Through this bore, lubricant can pass from the second duct into the first part.

A second part of the connection is connected and carries lubricant to the first duct. If a planetary bolt is involved in the conveying of the lubricant, the lubricant first flows through the second duct, then through the first part, then through the second part, through the third duct, and finally through the first duct.

On the other hand, if no planetary bolt is involved in carrying the lubricant, the second part opens directly into the first duct. This means that the first duct is in direct lubricant-conveying connection with the second part. Analogously with he first part, for this purpose the second part can be provided with a bore. The lubricant then flows from the second part through the bore directly into the first duct. In particular, the lubricant then does not flow through a planetary bolt.

As described in the document WO 03/078870 A1, the first part can be in the form of a U-shaped ring or U-ring. In this case the first part is connected fixed to the planetary carrier. In particular, the first part rotates with the planetary carrier.

The second part is preferably a ring-shaped groove running in the transmission housing. The U-ring rotates in this groove. The U-ring engages in the groove in such manner that no lubricant can escape. To convey the lubricant, both the U-ring and the groove are in lubricant-conveying connection with the above-described duct system.

Instead of on the planetary carrier, the U-ring can alternatively be attached on the transmission housing. Correspondingly, the planetary carrier must then have the ring-shaped groove.

The transmission according to the invention is particularly suitable for use in a wind power machine having a rotor and a rotor bearing, wherein at least some of the lubricant emerging from the first duct can make its way into the rotor bearing. Correspondingly, the rotor bearing is the above-mentioned bearing of the planetary carrier. In the axial direction or in the direction of the rotational axis of the rotor and the planetary carrier, this bearing is arranged between the rotor hub and the planetary stage, or the planetary carrier, the planetary bolt, the planetary gearwheel and a ring gear that meshes with the planetary gearwheel or a sun gear that meshes with the planetary gearwheel.

As a rule the planetary carrier is mounted in the transmission housing by means of two bearings. The invention can be further developed to the effect that not just one of these bearings is lubricated, i.e. lubricant emerging from the first duct into the cavity passes at least partially into just one of the two bearings, but rather, analogously with the first duct, a further duct is provided, from which lubricant can emerge into a further cavity formed by at least a further component of the transmission housing, at least a further component of the planetary carrier and at least a further component of the second bearing, so that at least some of the lubricant reaches the second bearing.

### BRIEF DESCRIPTION OF THE DRAWINGS

Below, the figures illustrate example embodiments of the invention which are described in greater detail. In the figures, the same indexes denote the same or functionally equivalent features.

In detail, the figures show:

FIG. 1: The supply of lubricant to a rotor bearing by way of a duct in the planetary carrier;

FIG. 2: The supply of lubricant to a rotor bearing by way of an added extension; and

FIG. 3: A special arrangement of the duct for supplying lubricant.

### DETAILED DESCRIPTION OF THE PREFERRED EMBODIMENTS

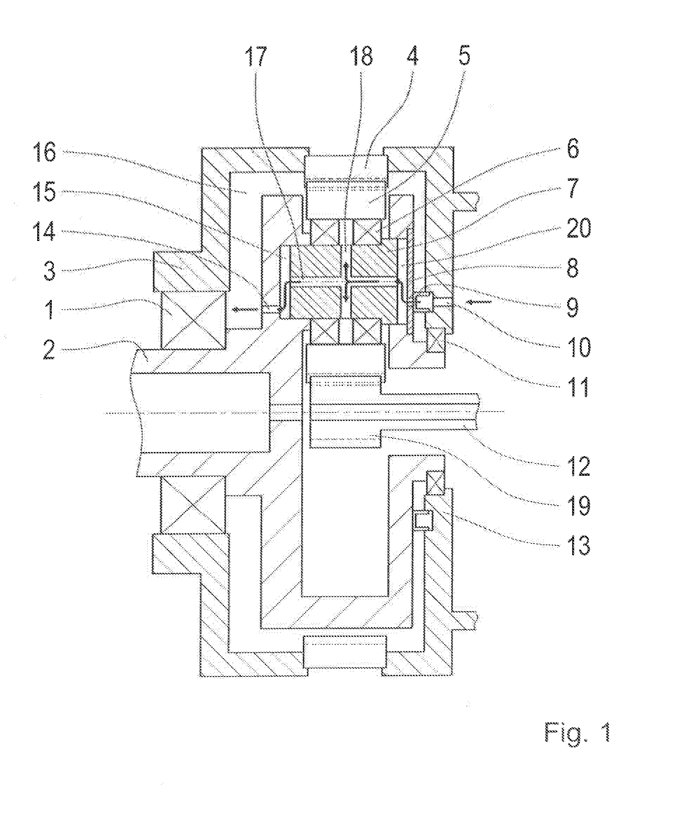

A planetary stage according to FIG. 1 comprises a planetary carrier 2 which is mounted in a transmission housing by means of a rotor bearing 1 and a further bearing 11. The transmission housing has a first housing half 3 and a second housing half 13. Another part of the transmission housing is formed by a ring gear 4, which is arranged between the first housing half 3 and the second housing half 13.

By means of two bearings 6, a planetary gearwheel 5 is fitted on a planetary bolt 7, which bolt is fixed in the planetary carrier 2. The planetary gearwheel 5 meshes on one side with the ring gear 4 and on the other side with a sun gear 19, which drives a sun gear shaft 12.

The rotor bearing 1 is supplied with lubricant as follows:

Lubricant pressurized by a pressure lubrication system is passed into a second duct 10, which extends through the second housing half 13. The second duct opens into a ring-shaped groove formed in the second housing half 13. This groove extends in the circumferential direction around the common rotational axis of the sun gear shaft 12 and the planetary carrier 2. A U-ring 9 engages in the groove in such manner that the two of them enclose an annular hollow space with a rectangular cross-section.

The planetary carrier 2 has a bore, into which the planetary bolt 7 is set. This bore is covered by a disk 8. Thus, the disk 8, the planetary bolt 7 and the planetary carrier 2 form a cavity 20. In addition the disk 8 has a bore, which connects the cavity 20 in a lubricant-conveying manner to the cavity formed by the U-ring 9 and the ring-shaped groove. Accordingly, the lubricant passes from the second duct 10, through the last-mentioned cavity and the bore in the disk 8, into the cavity 20 formed by the planetary bolt 7, the disk 8 and the planetary carrier 2.

The planetary bolt 7 has a third duct 17 that extends in its axial direction. This connects the cavity 20 formed by the planetary bolt 7, the disk 8 and the planetary carrier 2 to a further cavity 15 formed by the planetary carrier 2 and the planetary bolt 7. Thus, through the third duct 17 at least a first fraction of the lubricant passes into the cavity 15 formed by the planetary carrier 2 and he planetary bolt 7.

The planetary carrier 2 has a first bore 14, which connects the cavity formed by the planetary carrier 2 and the planetary bolt 7 to a further cavity 16 formed by part of the rotor bearing 1, part of the first housing component 3 and part of the planetary carrier 2. Thus, from the first-mentioned cavity 15 lubricant passes through the first duct 14 into the last-mentioned cavity 16.

Since the planetary carrier 2 rotates in the transmission housing, the lubricant is subjected to centrifugal forces. To ensure that the lubricant reaches the rotor bearing 1 and does not run outward along the planetary carrier 2, the first duct 14 is designed such that the lubricant emerging from the first duct 14 into the cavity 16 formed by part of the housing component 3, part of the planetary carrier 2 and part of the rotor bearing 1 is sprayed directly onto the rotor bearing 1.

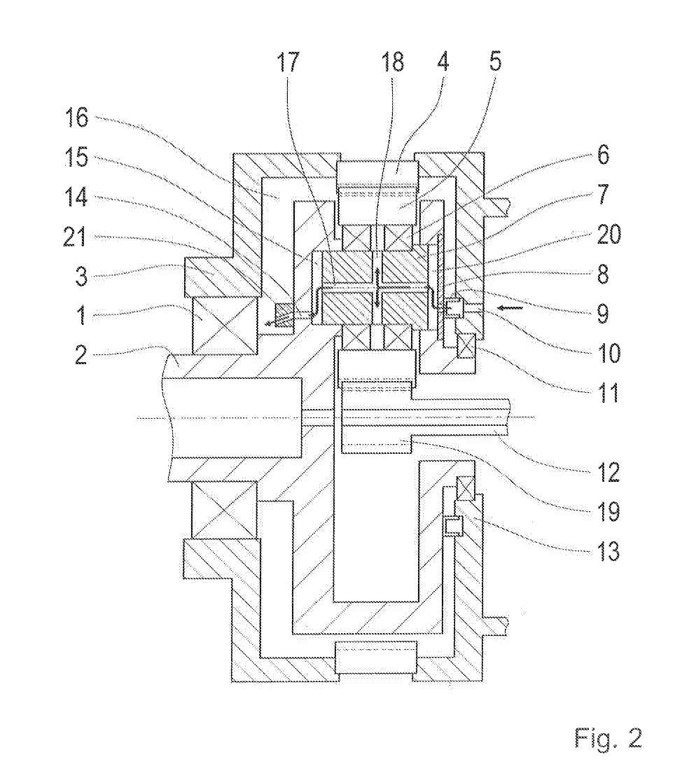

The embodiment shown in FIG. 2 differs from the embodiment shown in FIG. 1 in that the first duct 14 is formed not just by a bore in the planetary carrier 2, but in addition by an extension 21 attached at the outlet of that bore 14. The extension serves mainly to bring the point at which the lubricant emerges from the first duct 14 into the cavity 16 formed by part of the first housing component 3, part of the planetary carrier 2 and part of the rotor bearing 1, closer to the rotor bearing 1. Thus, the lubricant jet emerging from the first duct 14 can be directed in a more targeted and precise manner onto the rotor bearing 1.

A fourth duct 18 extends perpendicularly to the third duct 17. As described in the document WO 03/078870 A1, the fourth duct 18 opens into an area between the two bearings 6 of the planetary gearwheel 5. Thus, by means of the fourth duct 18, a second fraction of the lubricant is supplied to the two bearings 6 of the planetary gearwheel 5.

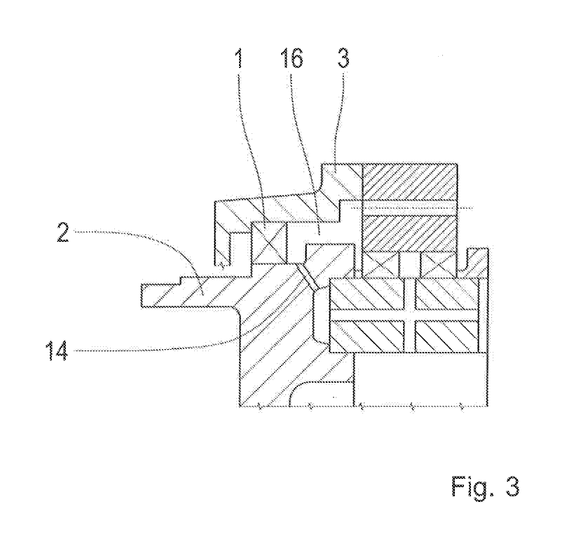

It is possible to direct the first duct 14 so that the lubricant is not sprayed onto the rotor bearing 1, but flows along the planetary carrier 2 into the rotor bearing 1. This can perhaps be necessary in embodiments of the planetary stage having a rotor bearing 1 with very large dimensions, as shown in FIG. 3.

In the case of a rotor bearing 1 with a very large diameter, the planetary carrier 2 does not provide sufficient space to orientate the first duct 14 so that the lubricant can be sprayed into the rotor bearing 1. In this case, however, the first duct 14 can be directed so that the lubricant emerges onto an axially extending surface or preferably onto a surface of the planetary carrier 2 that extends from the first duct 14, radially outward to the rotor bearing 1.

In contrast, if the lubricant emerges from the first duct 14 onto a surface that extends radially outward away from the rotor bearing 1, the consequence would be that the lubricant would flow outward along that surface without reaching the rotor bearing 1.

It has been found particularly advantageous to point the first duct 14 directly at the inner race of the rotor bearing 1. Thus, the first duct 14 opens onto the inner race of the rotor bearing 1 in the cavity formed by part of the first housing component 3, part of the planetary carrier 2 and part of the rotor bearing 1. Owing to the centrifugal forces produced by the rotation of the planetary carrier 2, the lubricant emerging from the first duct 14 into this cavity 16 now flows along the inner race and into the rotor bearing 1.

### INDEXES

1 Rotor bearing
2 Planetary carrier
3 First housing half
4 Ring gear
5 Planetary gearwheel
6 Bearing
7 Planetary bolt
8 Disk
9 U-ring
10 Second duct
11 Bearing
12 Sun gear shaft
13 Second housing half
14 First duct
15 Cavity
16 Cavity
17 Third duct
18 Fourth duct
19 Sun gear
20 Cavity
21 Extension

1-8. (canceled)

9. A transmission with a transmission housing (3, 4, 13) and at least one planetary stage;
the planetary stage comprising at least one planetary carrier (2) with at least one first duct (14) for conveying lubricant;
the planetary carrier (2) being mounted to rotate within the transmission housing (3) by at least one bearing (1);
at least part of the transmission housing (3), at least part of the planetary carrier (2) and at least part of the bearing (1) forming a cavity (16); and
the first duct (14) being designed such that lubricant emerges from the first duct (14) into the cavity (16) so that at least some of the lubricant reaches the bearing (1).

10. The transmission according to claim 9, wherein at least one element (21), which together with the planetary carrier (2), forms the first duct (14), and the at least one element is attached on the planetary carrier (2) such that the lubricant, which passes from the first duct (14), at least one of:
flows from the planetary carrier (2) through the at the at least one element (21), and
emerges from the first duct (14), via the at least one element (21), into the cavity (16).

11. The transmission according to claim 9, wherein the first duct (14) leads into a nozzle from which the lubricant emerges into the cavity (16).

12. The transmission according to claim 9, wherein the transmission housing (3) comprises at least one second lubricant-conveying duct (10), and at least one means (7, 8, 9, 15) is provided for conveying at least a first fraction of the lubricant from the second duct (10) to the first duct (14).

13. The transmission according to claim 12, wherein at least one planetary bolt (7) is designed as the means for conveying the first fraction of the lubricant from the second duct (10) into the first duct (14).

14. The transmission according to claim 13, wherein the planetary bolt is designed for conveying a second fraction of the lubricant to at least one bearing (6), by which a planetary gearwheel (5) is mounted to rotate on the planetary bolt (7).

15. The transmission according to claim 12, further comprising,
a lubricant-conveying, two-part connection between the transmission housing (13) and the planetary carrier (2), such that
a first part of the two-part connection (g) opens into the first duct (14), and
a second part of the two-part connection opens into the second duct (10).

16. A wind power machine with a rotor, a rotor bearing and a transmission comprising a transmission housing (3, 4, 13) and at least one planetary stage;
the planetary stage comprising at least one planetary carrier (2) with at least one first duct (14) for conveying lubricant;
the planetary carrier (2) being mounted to rotate in the transmission housing (3) by at least one bearing (1);
at least part of the transmission housing (3), at least part of the planetary carrier (2) and at least part of the bearing (1) forming a cavity (16);
the first duct (14) being designed such that lubricant emerges from the first duct (14) into the cavity (16) so that at least some of the lubricant reaches the bearing (1); and
at least some of the lubricant emerging from the first duct (14) into the cavity (16) being directed into the rotor bearing (1).

17. A transmission in combination with a wind power machine having a rotor and a rotor bearing, the transmission comprising:
a transmission housing enclosing at least one planetary stage which has a sun gear, a ring gear and a planetary carrier that rotatably supports a planetary gearwheel;
the planetary carrier being rotatably supported within the transmission housing by at least one bearing, and the planetary carrier comprises at least one first duct for conveying lubricant axially therethrough;
a cavity being formed within the transmission housing and delineated by at least part of the transmission housing, at least part of the planetary carrier and at least part of the bearing; and
the first duct extending through the planetary carrier such that lubricant flowing through the first duct, in the planetary carrier passing from the first duct into the cavity and being directed at the bearing.
